(19) United States
(12) Patent Application Publication
(10) Pub. No.: US 2002/0190676 A1
(43) Pub. Date: Dec. 19, 2002

(54) Control Circuit for a law-speed fan

(75) Inventors: Alex Horng, Kaohsiung (TW); Cheng Chung-Ken, Kaohsiung (TW)

Correspondence Address: Bacon & Thomas, 4th Floor, 625 Slaters Lane, Alexandria, VA, 22314, US

(73) Assignee: Sunonwealth Electric Maqchine Industry Co., Ltd., Kaohsiung (TW)

(21) Appl. No.: 09/880,799

(22) Filed: Jun. 15, 2001

(51) Int. Cl. H02P 1/00; H02P 1/22; H02P 1/40; H02P 3/00; H02P 3/20; H02P 5/00; H02P 7/00

(52) U.S. Cl. 318/268

(57) ABSTRACT

A control circuit for a low-speed fan is connected between a power source and a drive circuit for a low-speed fan. The control circuit comprises a Zener diode and a transistor for stepping down the voltage to thereby output a preset working voltage suitable for low speed mode operation of the fan and to thereby avoid the drawbacks of uneasy or unsuccessful starting of the fan resulting from input of low or unstable power source voltage.

### BACKGROUND OF THE INVENTION

1. Field of the Invention

The present invention relates to a control circuit for a low-speed fan and, more particularly, to a control circuit that utilizes a step-down circuit to lower the power source voltage such that a stable working voltage suitable for low speed operation of a fan is outputted to start and operate the fan and that the fan operates smoothly when it operates in a low speed mode and thus has a longer longevity.

2. Description of the Related Art

Heat-dissipating fans are widely used in computers and their peripherals to avoid a rise in temperature as a result of poor heat-dissipation that may lead to down of systems and/or burning of electronic elements. Low speed operation of a fan is sufficient to heat-dissipation of a system not having a high inner temperature. However, unnecessary load is added to the fan and noise occurs when the fan operates at high speed.

Taiwan Utility Model Publication No. 204795 issued on Apr. 21, 1993 and entitled “VARIABLE SPEED CONTROLLING DEVICE FOR A FAN MOTOR” discloses a controlling device in which an A.C. power source circuit is in serial connection with a step-down capacitor, which, in turn, is connected to a rectifier to provide a D.C. power source. A voltage-adjusting unit, a current divider unit, and a fan motor whose speed is to be controlled are connected in parallel between outputs of the D.C. power source. The voltage-adjusting unit comprises a plurality of Zener diodes and a selective switch. The Zener diodes are connected in series with the positive pole of each Zener diode leading to the positive pole of the D.C. power source. Two resistors are connected in series with two outermost Zener diodes, respectively. A common connection of the selective switch is connected to an outermost connection of the Zener diodes. The remaining selective connections of the selective switch are connected to the remaining connections of the Zener diodes, respectively. The current divider unit is in the form of a transistor with the collector and the emitter being connected to the positive pole and the negative pole of the D.C. power source, respectively. The base of the transistor is connected to the outermost connection of the Zener diodes. By means of operating the selective switch, the effective serial break voltage value of the serially connected Zener diodes can be varied while cooperating with the conductive current of the current divider unit to increase the step-down of the step-down capacitor, thereby varying the voltage value after rectification and thus varying the speed of the fan motor. Nevertheless, the voltage-adjusting unit and the current divider unit consist of too many electronic elements and are only suitable to control speed of the fan motor, not suitable to control low-speed motors.

The smallest wire diameter for current windings for fan motors is 0.05 mm. However, a fan motor comprising a stator that utilizes 0.05 mm wires cannot meet the demand of lowering the rated power source voltage for providing a stable working voltage value for low speed operation. As illustrated in FIG. 1 of the drawings, in a typical arrangement for lowering the working voltage, a resistor R is provided before the fan and the rated voltage V1 to thereby provide a fixed step-down. A reduced rated voltage V2 is thus provided for low speed operation of the fan. Nevertheless, the fan cannot be started when the input to the power source voltage Vcc is slightly lower than the rated voltage V1, as the preset working voltage V2 cannot be obtained due to the fixed step-down effect by the resistor R. Thus, the conventional design of using a resistor to provide a fixed step-down for providing a working stable working voltage for low-speed fan operation cannot assure normal starting of the fan in view of possible fluctuation in or unstableness of the inputted power source. The arrangement of a serially connected resistor in front of the winding of the fan motor is not reliable. For a low-speed fan, the preset working voltage must be provided to assure smooth starting and normal operation of the fan motor regardless of fluctuation in or unstableness of the inputted power source.

### SUMMARY OF THE INVENTION

It is the primary object of the present invention to provide a control circuit for a low-speed motor, wherein the control circuit comprises a Zener diode and a transistor for stepping down the voltage, thereby obviating the drawbacks of uneasy or unsuccessful starting of the fan resulting from an input of low or unstable power source voltage.

It is another object of the present invention to provide a control circuit for a low-speed motor, wherein the control circuit comprises a Zener diode and a transistor for stepping down the voltage to thereby output a stable working voltage. The low-speed fan operates smoothly and thus has a longer longevity.

The control circuit for a low-speed fan in accordance with the present invention is connected between a power source and a drive circuit for a low-speed fan. The control circuit comprises a Zener diode and a transistor for stepping down the voltage to thereby output a preset working voltage suitable for low speed mode operation of the fan and to thereby avoid the drawbacks of uneasy or unsuccessful starting of the fan resulting from input of low or unstable power source voltage. In addition, the control circuit outputs a stable working voltage to thereby prolong the longevity of the fan.

Other objects, specific advantages, and novel features of the invention will become more apparent from the following detailed description and preferable embodiments when taken in conjunction with the accompanying drawings.

### BRIEF DESCRIPTION OF THE DRAWINGS

FIG. 1 is a schematic diagram of a conventional control circuit for a low-speed fan.

FIG. 2 is a diagram of a control circuit for a low-speed fan in accordance with the present invention.

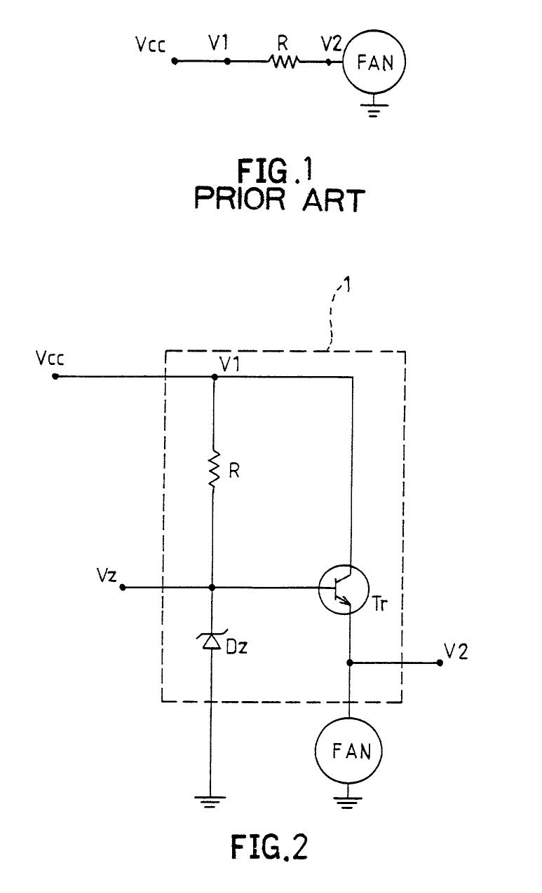

### DETAILED DESCRIPTION OF THE PREFERRED EMBODIMENT

A preferred embodiment in accordance with the present invention will now be described with reference to the accompanying drawings.

Referring to FIG. 2, a control circuit for a low-speed fan in accordance with the present invention is designated by “1” and serially connected between a power source Vcc and a drive circuit FAN of a low-speed fan. The control circuit 1 comprises a resistor R, a Zener diode Dz, and a transistor Tr. The resistor R and the Zener diode Dz are serially connected between the power source Vcc and the ground. The negative pole of the Zener diode Dz is serially connected between the resistor R and the base of the transistor Tr. The positive pole of the Zener diode Dz is connected to the ground. The collector of the transistor Tr is connected to the power source Vcc and the emitter of the transistor Tr is connected to the drive circuit FAN. In addition, the base of the transistor Tr is connected between the resistor R and the Zener diode Dz. The voltage inputted to the power source Vcc is defined as a rated voltage V1 and the working voltage for stably operating the fan at low speed is designated by “V2”. The break voltage of the Zener diode Dz is designated by “Vz”. Further, a wire having the smallest diameter (i.e., 0.05 mm) is selected for winding. Preferably, the resistance of the resistor is (V1-V2)/5 KΩ, the break voltage Vz=V2+0.7V, and the power ratio is greater than (V1-V2)×I, wherein I is the locking current of the fan. Thus, the break voltage Vz of the Zener diode Dz is decided by the voltage Vbe (about 0.7V) between the base and the emitter of the transistor Tr after conduction and the working voltage V2 of the fan. If the rated voltage V1 is lower than the break voltage Vz of the Zener diode Dz and higher than the working voltage V2, the Zener diode Dz is open while the transistor Tr is conductive to thereby provide a working voltage V2 suitable for smooth operation for the fan. If the rated voltage V1 is higher than the break voltage Vz of the Zener diode Dz, the Zener diode Dz is closed and thus grounded. Thus, the Zener diode Dz is provided to consume all of the redundant voltage (V1-Vz) while the transistor Tr is conductive and provides the fan with a stable working voltage V2. As a result, the rated voltage V1 provides the fan with a stable voltage V2 for stable operation and starting as long as the former is not lower than the break voltage Vz of the Zener diode Dz.

Referring to FIG. 2, during operation of the fan, assume that the rated voltage V1 is 12V, the break voltage Vz is equal to 7.7V, and the working voltage V2 for stable operation and starting of the fan is 7V. When the rated voltage V1 is lowered to be about 7.7 V (the value of the break voltage Vz), the Zener diode Dz is open and the transistor Tr is conductive. The working voltage V2 is equal to V1-Vbe, i.e., 7V (7.7V-0.7V), which is enough for the working voltage. When the rated voltage V1 exceeds 7.7V, the Zener diode Dz is closed and thus grounded to thereby consume all of the redundant voltage (V1-Vz) while the working voltage V2 (i.e., Vz-Vbe) is still 7V that is enough for the working voltage. The control circuit of the present invention assures reliable starting and smooth operation of the fan by means of using a Zener diode Dz and a transistor Tr even if the rated voltage V1 is at the rated value or lowered to be about the working voltage V2 of the fan.

By contrast, if the control circuit in accordance with the present invention is replaced by the conventional design that uses a serially connected resistor to obtain the step-down for a low-speed fan, the working voltage V2 fluctuates in response to variation of the rated voltage V1 and thus fails to provide stable rotational speed and might be unable to start the fan.

Although the invention has been explained in relation to its preferred embodiment as mentioned above, it is to be understood that many other possible modifications and variations can be made without departing from the scope of the invention. It is, therefore, contemplated that the appended claims will cover such modifications and variations that fall within the true scope of the invention.

What is claimed is:

1. A control circuit for a low-speed fan, the control circuit being connected between a power source and a drive circuit of a low-speed fan, the power source providing a rated voltage, the control circuit comprising:
a transistor comprising a collector connected to the power source, an emitter connected to the drive circuit, and a base; and
a Zener diode comprising a positive pole connected to the power source and the base of the transistor and a negative pole connected to ground;
wherein when the rated voltage provided by the power source is equal to a break voltage of the Zener diode, the Zener diode is open and the transistor is conductive such that the emitter of the transistor provides a working voltage suitable for starting and operating the low-speed fan; and
wherein when the rated voltage provided by the power source is higher than the break voltage of the Zener diode, the Zener diode is closed and grounded to thereby consume redundant voltage while the transistor is conductive such that the emitter of the transistor provides the working voltage suitable for starting and operating the low-speed fan.

2. The control circuit for a low-speed fan as claimed in claim 1, wherein the control circuit further comprises a resistor connected between the power source and the Zener diode, the base of the transistor being connected between the resistor and the Zener diode.

3. The control circuit for a low-speed fan as claimed in claim 1, wherein the break voltage of the Zener diode is higher than the working voltage suitable for starting the low-speed fan by 0.7 V.
